(19) United States
(12) Patent Application Publication
(10) Pub. No.: US 2025/0115213 A1
(43) Pub. Date: Apr. 10, 2025

(54) Universal Windshield Wiper Connector Adapter

(71) Applicant: Chunting Huang, Chenzhou (CN)

(72) Inventor: Chunting Huang, Chenzhou (CN)

(21) Appl. No.: 18/892,774

(22) Filed: Sep. 23, 2024

Related U.S. Application Data
(60) Provisional application No. 63/587,790, filed on Oct. 4, 2023.

(51) Int. Cl. B60S 1/40

(52) U.S. Cl. CPC B60S 1/4003

(57) ABSTRACT

An universal windshield wiper connector adapter for attaching a single unit to the various multiple wiper arm models encountered in different car manufacturers. The adapter has a base that connects to the wiper blade assembly, and a top that has uniquely placed openings that will secure it to at least one of the following wiper arm holders, 9*3, 9*4, 7 MM, PIN- 3/16, PIN-¼, 6 #and/or 4 #.

### CROSS-REFERENCE TO RELATED APPLICATIONS

This application claims priority to co-pending U.S. Provisional patent applications Ser. No. 63/587,790 titled “Universal Windshield Wiper Connector Adapter”, filed on Oct. 4, 2023, the disclosure of which is herein incorporated by reference in its entirety.

### PATENTS CITED

The following documents and references are incorporated by reference in their entirety, Tolentino et al (U.S. Pat. Nos. 9,505,380; 11,565,661), Fink et al (U.S. Pat. No. 7,891,044), Scholl et al (U.S. Pat. No. 7,716,780) and Tufts et al (U.S. Pat. No. 11,529,931).

### FIELD OF THE INVENTION

This disclosure generally relates to the interface between the windshield wiper blade and the vehicle, and more particularly, to a universal windshield wiper blade connector adapter that allows the mechanical connection of a wiper blade to multiple vehicles wiper arms.

### DESCRIPTION OF THE RELATED ART

The wiper blade is used to remove moisture from a vehicle's windshield. While the specific windshield technology is similar (glass, plastic, straight, curved, etc.), each vehicle designer then designs both a specific length and a specific interface between the wiper blade and the wiper blade arm.

There are a variety of wiper arms on which wiper blades are provided as original equipment. These various wiper arms have hooks, pins, or other configurations which may connect to the wiper blade with or without connectors. These various configurations have created a problem in the replacement market because wiper blade providers are required to have multiple wiper blade configurations to accommodate all of the existing wiper arms. It is therefore advantageous to have a wiper connector attachment structures that can accommodate a host of vehicle arms in order to reduce the complexity and cost associated with plurality of wiper blade arm configurations.

Two commonly used wiper arms in the art include the single tongue wiper arm disclosed in U.S. Pat. No. 7,891,044, the entire contents of which is incorporated herein by reference, and the double tongue wiper arm disclosed in U.S. Pat. No. 7,716,780, the entire contents of which are incorporated herein by reference.

Similarly there are many others that require the adaptor to be changed/modified by the user, and/or thrown out. What is required is a simpler connector that is on the wiper assembly and simply accepts any vehicle arm.

### SUMMARY OF THE INVENTION

This section is for the purpose of summarizing some aspects of the present invention and to briefly introduce some embodiments. Simplifications or omissions may be made to avoid obscuring the purpose of the section. Such simplifications or omissions are not intended to limit the scope of the present invention.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e., that it will be taken to mean an inclusion of not only the listed components it directly references, but also other non-specified components or elements. This rationale will also be used when the term ‘comprised’ or ‘comprising’ is used in relation to one or more steps in a method or process.

In one aspect, the invention is about a universal windshield wiper connector adapter for mechanically securing a wiper blade assembly with multiple models of vehicle wiper arms, said adapter comprising: an upper portion body having an upper and a lower areas, said upper area having mechanical fittings that couple with seven wiper arm terminations, with one of said fittings holding one said wiper arm termination inside and a different one outside the same fitting holder, a lower body portion having dimensions complementary to a universal base and having a coupler opening and a universal base that is mechanically attached to the wiper blade body, said universal base having an opening complementary to the dimensions of said upper body's bottom, with a central bar designed to couple with said lower body's coupler opening. In another aspect the fitting holding the wiper arm termination inside is a PIN-¼, whose front external side is sized to hold a 9*3 or 9*4 wiper arm. In yet another aspect the seven wiper arm terminations are: 9*3, 9*4, 7 MM, PIN- 3/16, PIN-¼, 6 #and 4 #wiper arm terminations.

Other features and advantages of the present invention will become apparent upon examining the following detailed description of an embodiment thereof, taken in conjunction with the attached drawings, which are provided for purposes of illustration and not of limitation.

### BRIEF DESCRIPTION OF THE DRAWINGS

FIG. 1 shows a perspective view of a universal windshield wiper adapter connected to a wiper, according to an exemplary embodiment of the invention.

FIG. 2 shows a perspective view of a universal windshield wiper adapter, according to an exemplary embodiment of the invention.

FIG. 3 shows a front view of a universal windshield wiper adapter, according to an exemplary embodiment of the invention.

FIG. 4 shows a back view of a universal windshield wiper adapter, according to an exemplary embodiment of the invention.

FIG. 5 shows a right-side view of a universal windshield wiper adapter, according to an exemplary embodiment of the invention.

FIG. 6 shows a left-side view of a universal windshield wiper adapter, according to an exemplary embodiment of the invention.

FIG. 7 shows a top view of a universal windshield wiper adapter, according to an exemplary embodiment of the invention

FIG. 8 shows a bottom view of a universal windshield wiper adapter, according to an exemplary embodiment of the invention.

FIG. 9 shows a universal windshield wiper adapter connected to a vehicle's wiper arm of the PIN- 3/16 type, according to an exemplary embodiment of the invention.

FIGS. 10 shows a universal windshield wiper adapter connected to a vehicle's wiper arm of the 9*3 or 9*4 type, according to an exemplary embodiment of the invention.

FIG. 11 shows a front view of a universal windshield wiper adapter with attached wiper, according to an exemplary embodiment of the invention.

FIG. 12 shows the various types of vehicle arms to which the universal windshield wiper adapter connects, according to an exemplary embodiment of the invention.

FIG. 13 shows a universal windshield wiper adapter connecting to a 9*3 type vehicle's wiper arm, according to an exemplary embodiment of the invention.

FIG. 14 shows a universal windshield wiper adapter connecting to a 9*4 type vehicle's wiper arm, according to an exemplary embodiment of the invention.

FIG. 15 shows a universal windshield wiper adapter connecting to a 7 MM type vehicle's wiper arm, according to an exemplary embodiment of the invention.

FIG. 16 shows a universal windshield wiper adapter connecting to a PIN- 3/16 type vehicle's wiper arm, according to an exemplary embodiment of the invention.

FIG. 17 shows a universal windshield wiper adapter connecting to a PIN-¼ type vehicle's wiper arm, according to an exemplary embodiment of the invention.

FIG. 18 shows a universal windshield wiper adapter connecting to a 6 #type vehicle's wiper arm, according to an exemplary embodiment of the invention.

FIG. 19 shows a universal windshield wiper adapter connecting to a 4 #type vehicle's wiper arm, according to an exemplary embodiment of the invention.

The above-described and other features will be appreciated and understood by those skilled in the art from the following detailed description and drawings.

### DETAILED DESCRIPTION OF THE INVENTION

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

As used in the specification and claims, the singular forms “a”, “an” and “the” include plural references unless the context clearly dictates otherwise. For example, the term “a transaction” may include a plurality of transaction unless the context clearly dictates otherwise. As used in the specification and claims, singular names or types referenced include variations within the family of said name unless the context clearly dictates otherwise.

Certain terminology is used in the following description for convenience only and is not limiting. The words “lower,” “upper,” “bottom,” “top,” “front,” “back,” “left,” “right” and “sides” designate directions in the drawings to which reference is made, but are not limiting with respect to the orientation in which the modules or any assembly of them may be used.

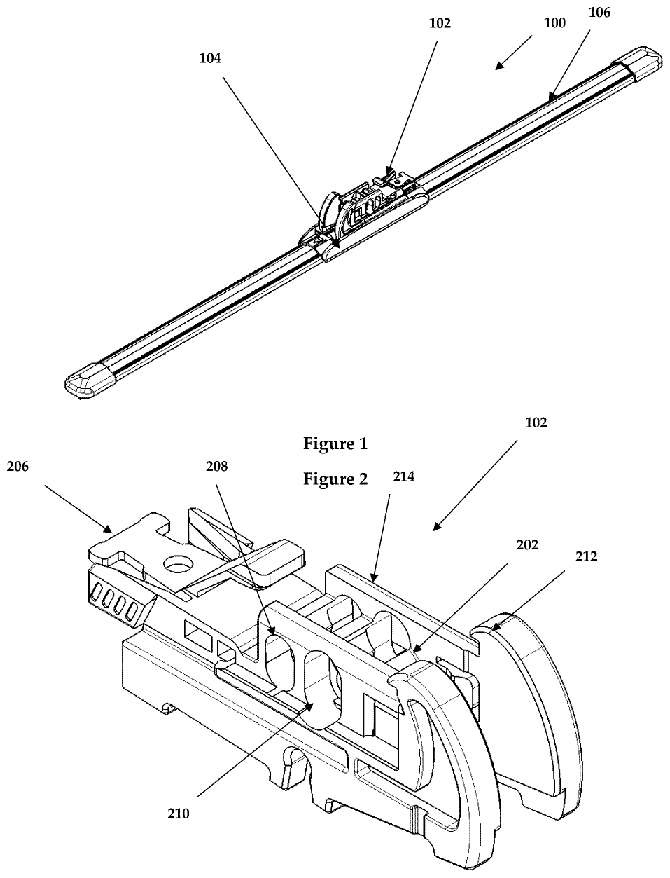

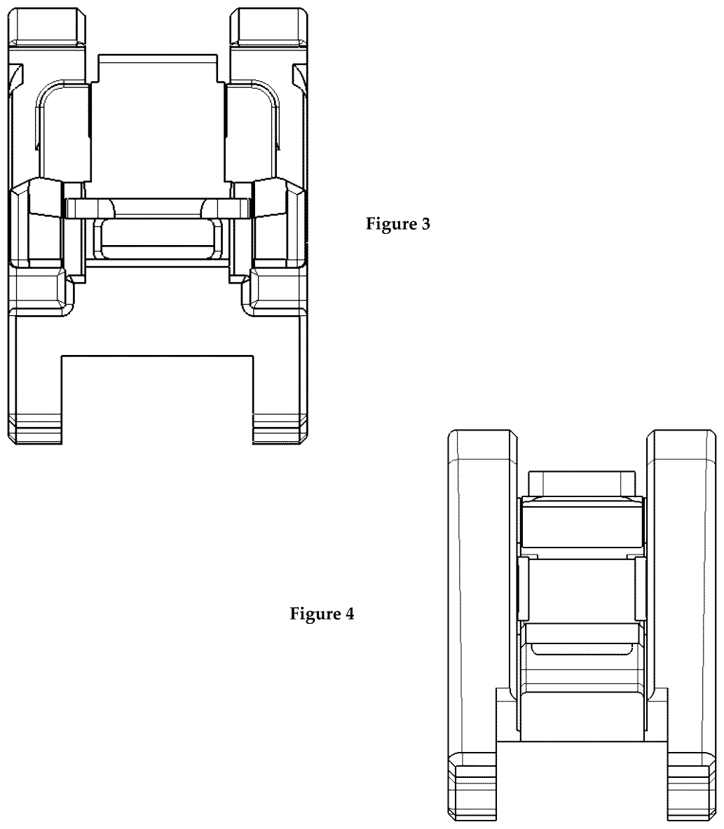

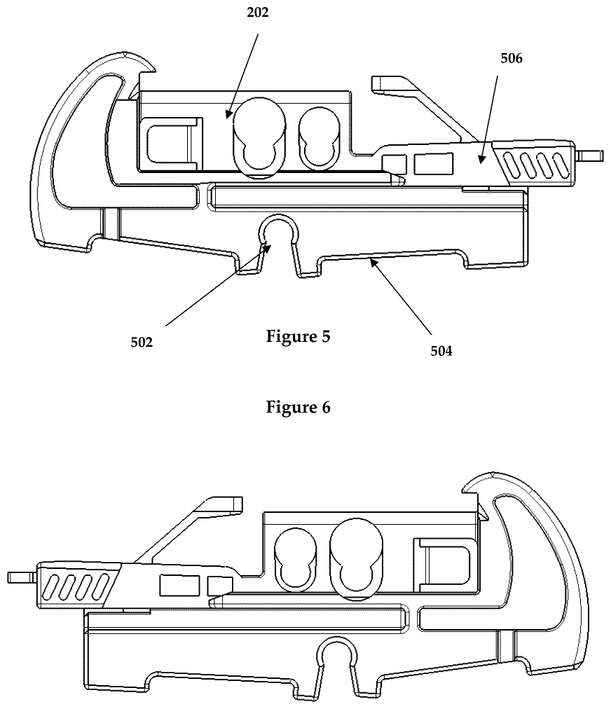

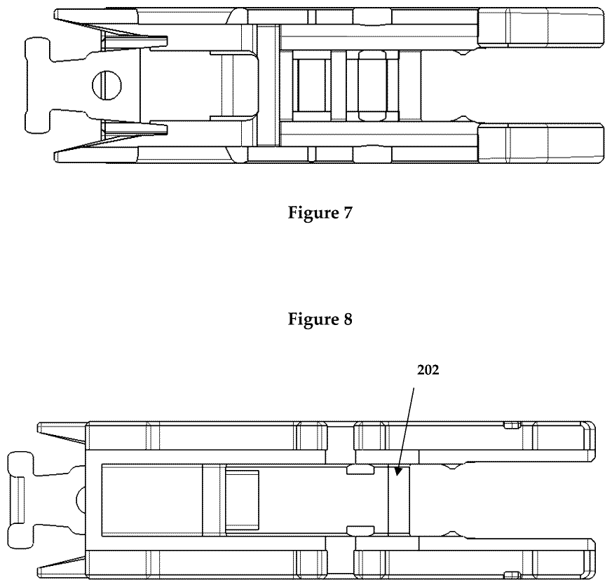

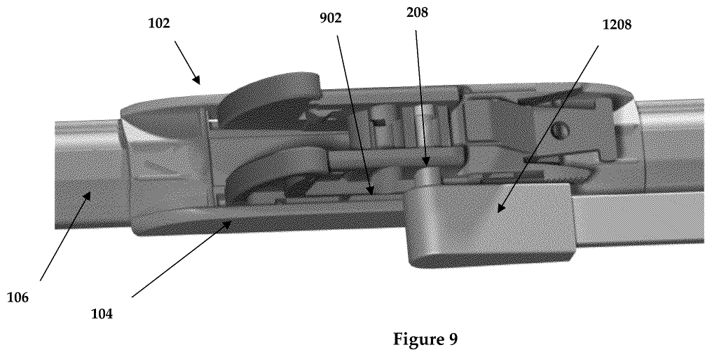

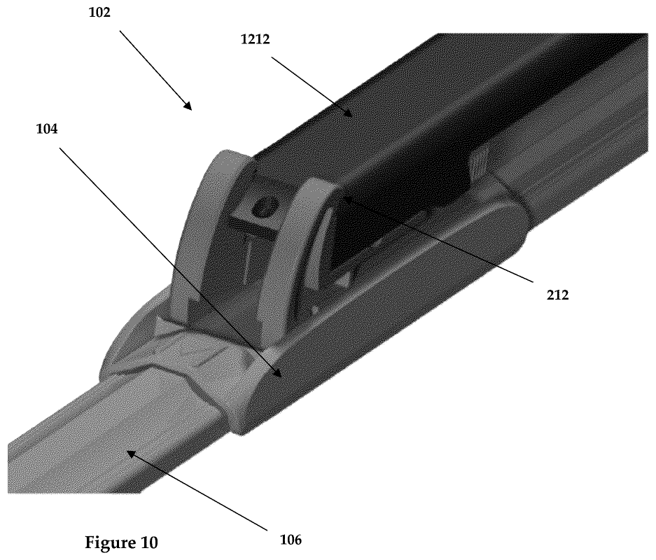

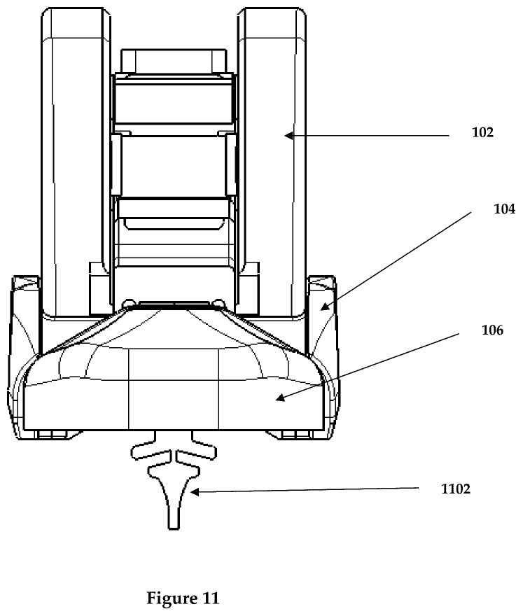

Due to the variety of vehicle manufactures, and to the desire of said mfrs. to control the after-market supply of wiper blades for their vehicles, vehicle owners are forced to look through myriad 17-inch wiper blades until they find the ones that match their vehicle's wiper arm configuration. The present invention, referring to FIGS. 1-12 is about a universal windshield wiper connector adapter 102 designed to couple a windshield wiper 106 via a base 104 to two or more types of different vehicle wiper arms.

The seven most popular vehicle wiper arm terminations are known as 9*3 1202, 9*4 1204, 7 MM 1206, PIN- 3/16 1208, PIN-¼ 1210, 6 #1212 and/or 4 #1214, again necessitating a different special connector adapter (per mfr.) to connect the wiper blade 1102 to the vehicle. What we propose, is single universal windshield wiper connector adapter body 102 having a universal base 104 that connects to the wiper blade assembly 106 that holds the wiper blade 1102.

To accomplish this, the unique adapter body 102 is comprised of a single body section 102 having strategically located openings/adapters to the vehicle wiper arm termination (1202, 1204, 1206, 1208, 1210, 1212 and/or 1214), and a lower coupler opening 502 and edges 504 that will couple with the inner portion of a second lower body portion 104, in order to securely grip/interface with the wiper body 106.

The above allows for a unique solution. Unlike the present situation (where you must search for your car brand's wiper blade at the store), here it is the wiper mfr. that internally decides how to interface the lower portion 104 to the actual wiper body 106, which is actually holding the wiper blade 1102. By clipping the lower body's 104 central bar 902 into the upper body's 102 lower coupler opening 502 (again, something done at the manufacturer's facility), the user buys an assembly 100 that can interface to any of the seven listed arm terminations (1202, 1204, 1206, 1208, 1210, 1212 and/or 1214). This allows for easy mfg. flexibility combined with ease of installation by the user or buyer. In another embodiment, the upper body 102 and lower body 104 are made into a single unit.

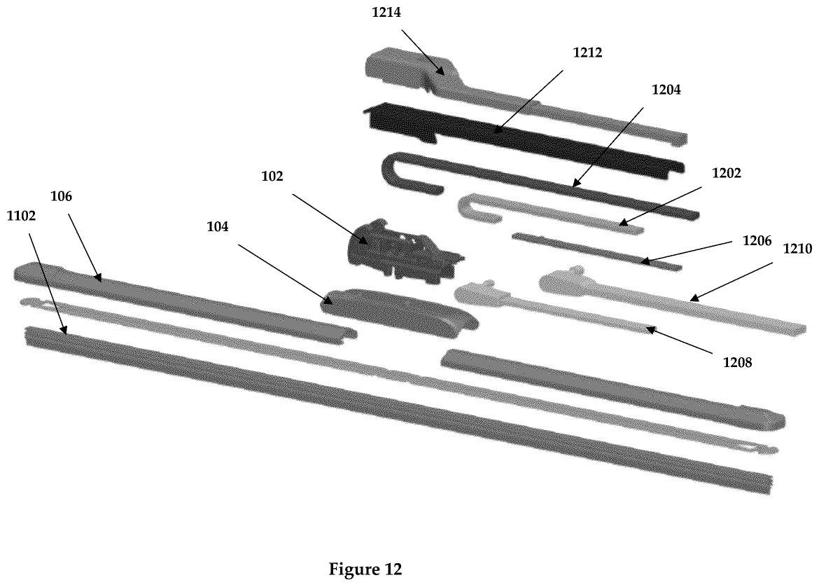

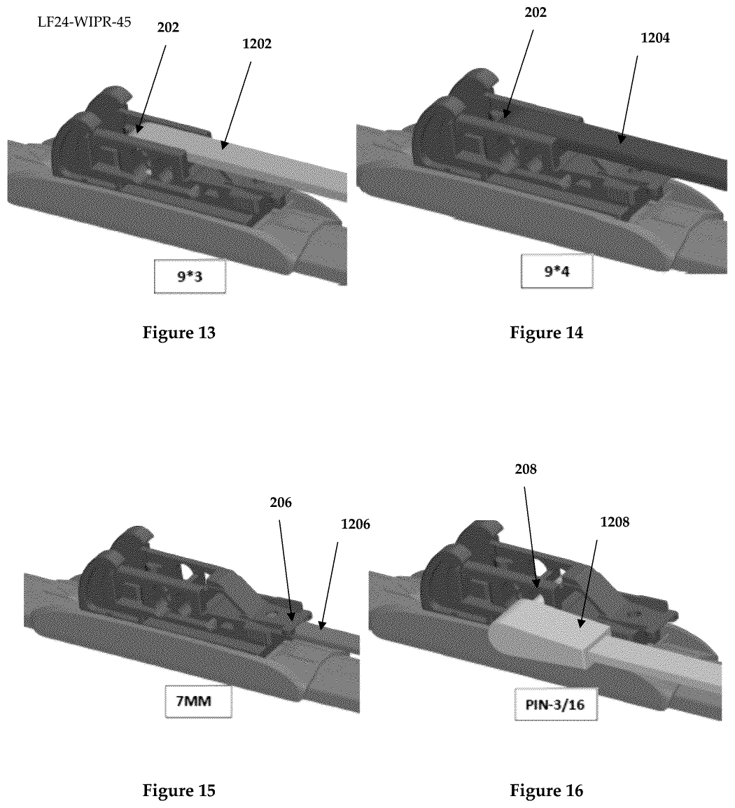

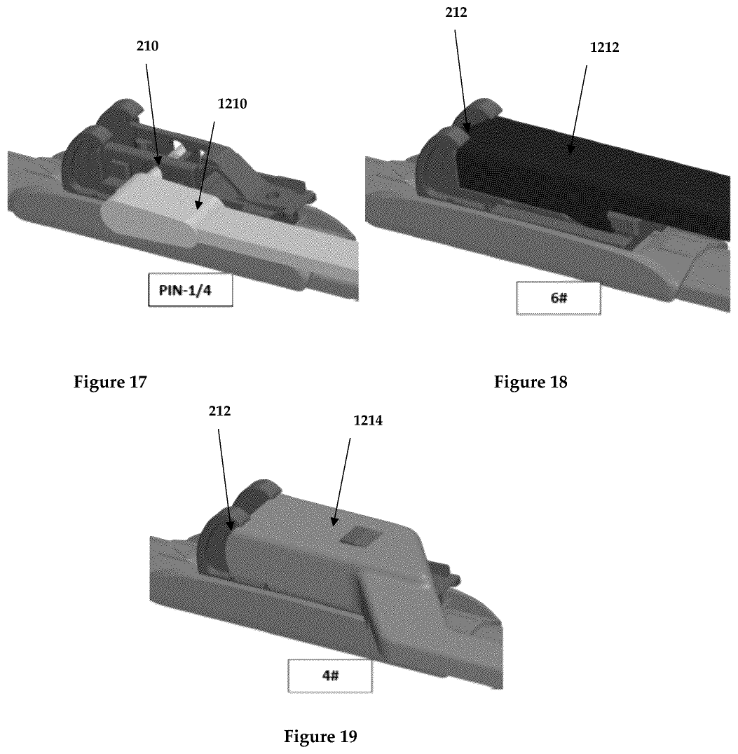

Referring to FIGS. 13-19 we see the connection of each of the various listed arm terminations (9*3 1202, 9*4 1204, 7 MM 1206, PIN- 3/16 1208, PIN-¼ 1210, 6 #1212 or 4 # 1214) to the adapter 102. As Seen in FIG. 12, the 9*3 1202 and 9*4 1204 vehicle mounts are horizontal hook shaped, and designed to be hosted within the front curvature 202 of the front opening 210. The 7 MM 1206 mount is a bayonet type, and it goes into the 206 slot at the end of the adapter 102, with a tab 506 that clicks in place and hold the bayonet.

The PIN- 3/16 1208 and PIN-¼ 1210 are side pins designed to be held respectively by the openings 208 and 210. Note that the ¼″ opening is placed in front, so that the 9*3 (13.5mm opening) and the 9*4 (19 mm opening) may slide over them. The 6 #1212 and 4 #1214 adapters respectively are held under the front clips 212 against and around the top rail 214. In the above fashion, the installer (be a user or buyer) can simply get a single unit of the specific length for their vehicle.

### CONCLUSION

In concluding the detailed description, it should be noted that it would be obvious to those skilled in the art that many variations and modifications can be made to the shown embodiments without substantially departing from the principles of the present invention. Also, such variations and modifications are intended to be included herein within the scope of the present invention as set forth in the disclosure.

It should be emphasized that the above-described embodiments of the present invention, particularly any “exemplary embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention.

1. A universal windshield wiper connector adapter for mechanically securing a wiper blade assembly with multiple models of vehicle wiper arms, said adapter comprising:
an upper portion body having an upper and a lower areas, said upper area having mechanical fittings that couple with seven wiper arm terminations, with one of said fittings holding one said wiper arm termination inside and a different one outside the same fitting holder;
a lower body portion having dimensions complementary to a universal base and having a coupler opening; and
a universal base that is mechanically attached to the wiper blade body, said universal base having an opening complementary to the dimensions of said upper body's bottom, with a central bar designed to couple with said lower body's coupler opening.

2. The connector adapter of claim 1 wherein;
the fitting holding the wiper arm termination inside is a PIN-¼, whose front external side is sized to hold a 9*3 or 9*4 wiper arm.

3. The connector adapter of claim 2 wherein:
the seven wiper arm terminations are:
9*3, 9*4, 7 MM, PIN- 3/16, PIN-¼, 6 #and 4 #wiper arm terminations.

4. The connector adapter of claim 1 wherein:
the seven wiper arm terminations are:
9*3, 9*4, 7 MM, PIN- 3/16, PIN-¼, 6 #and 4 #wiper arm terminations.
